(19) United States
(12) Patent Application Publication
(10) Pub. No.: US 2025/0131625 A1
(43) Pub. Date: Apr. 24, 2025

(54) IMAGE EDITING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Xinghua ZHANG, Beijing (CN); Zhirui CAI, Beijing (CN)

(21) Appl. No.: 18/695,753

(22) PCT Filed: Sep. 26, 2022
(86) PCT No.: PCT/CN2022/121192

§ 371 Date: Mar. 26, 2024

(30) Foreign Application Priority Data
Sep. 30, 2021 (CN) 202111165882.3

(51) Int. Cl. G06T 11/60

(52) U.S. Cl. CPC G06T 11/60; G06T 2200/24

(57) ABSTRACT

An image editing method and apparatus, an electronic device, and a storage medium are provided. The method includes: obtaining an original image including the first and second editing objects; rendering the first and second editing objects to different layers respectively, to generate the first and second original layers; rendering an editing result of the first editing object under a first editing operation based on the first original layer to generate the first editing layer in response to the first editing operation for the first editing object, and rendering an editing result of the second editing object under the second editing operation based on the second original layer to generate the second editing layer in response to the second editing operation for the second editing object; and generating, based on the first and second editing layers, a target image as an editing result of the original image.

This application claims the priority of Chinese Patent Application No. 202111165882.3 filed on Sep. 30, 2021 and entitled “IMAGE EDITING METHOD AND APPARATUS”, the disclosure of which is incorporated by reference herein in its entirety as part of the present application.

### TECHNICAL FIELD

The present application relates to the technical field of image processing, and in particular, to an image editing method and apparatus.

### BACKGROUND

When editing an image, there can often be a need for editing a plurality of objects in a same image. For example, when editing a group photo, there can often be a need for differently editing different human faces in the photo.

A multi-object editing method in a related technique is to divide an original image into a plurality of regions by region where an object needing to be edited is located in the original image, and then to edit the region corresponding to each object needing to be edited one by one on the original image. However, since such a multi-object editing method in the related technique is directed to editing on the original image, re-editing of a certain object needs to be done on the original image, and global rendering is performed on the editing results of other edited objects. Therefore, such a multi-object editing method in the related technique may have enormous performance overhead when re-editing an object in an image. For example, objects needing to be edited in an original image include a first object and a second object. A user may firstly edit the first object on the original image to generate a first intermediate image and then edit the second object on the first intermediate image to generate a second intermediate image. When the user is dissatisfied with the editing result of the first object in the second intermediate image and wants to re-edit the first object, since no intermediate image having only the editing result of the second object is generated during editing, the user needs to re-edit the first object on the original image to generate a third intermediate image, and to render the editing result of the second object on the third intermediate image to obtain a final target image. As objects needing to be edited in an image increase, objects requiring editing result rendering when re-editing an object in the image will increase accordingly, resulting in constantly increased performance overhead when re-editing the object in the image.

### SUMMARY

In view of the above problem, the present application provides an image editing method and apparatus that are intended to solve the problem of enormous performance overhead when re-editing an object in an image during multi-object editing.

To achieve the above objective, embodiments of the present application provide the following technical solutions.

In a first aspect, an embodiment of the application provides an image editing method, including:
obtaining an original image, wherein the original image includes a first editing object and a second editing object, and the first editing object and the second editing object are located in different image regions of the original image;
rendering the first editing object and the second editing object to different layers, respectively, to generate a first original layer corresponding to the first editing object and a second original layer corresponding to the second editing object;
rendering an editing result of the first editing object under a first editing operation based on the first original layer to generate a first editing layer corresponding to the first editing object in response to the first editing operation for the first editing object, and rendering an editing result of the second editing object under a second editing operation based on the second original layer to generate a second editing layer corresponding to the second editing object in response to the second editing operation for the second editing object; and
generating, based on the first editing layer and the second editing layer, a target image as an editing result of the original image.

In some embodiments, the rendering the first editing object and the second editing object to different layers, respectively, to generate a first original layer corresponding to the first editing object and a second original layer corresponding to the second editing object includes:
creating layers corresponding to the first editing object and the second editing object, respectively;
separately extracting image data corresponding to the first editing object and image data corresponding to the second editing object from the original image; and
rendering the layer corresponding to the first editing object based on the image data corresponding to the first editing object to generate the first original layer corresponding to the first editing object, and rendering the layer corresponding to the second editing object based on the image data corresponding to the second editing object to generate the second original layer corresponding to the second editing object.

In some embodiments, the separately extracting image data corresponding to the first editing object and image data corresponding to the second editing object from the original image includes:
determining an outline of the first editing object and an outline of the second editing object from the original image; and
extracting image data within the outline of the first editing object to obtain the image data corresponding to the first editing object, and extracting image data within the outline of the second editing object to obtain the image data corresponding to the second editing object.

In some embodiments, the separately extracting image data corresponding to the first editing object and image data corresponding to the second editing object from the original image includes:
determining an outline of the first editing object and an outline of the second editing object from the original image;
determining a first image data extraction region corresponding to the first editing object and a second image data extraction region corresponding to the second editing object based on the outline of the first editing object and the outline of the second editing object, respectively, wherein the outline of the first editing object is located in the first image data extraction region, and the outline of the second editing object is located in the second image data extraction region; and
extracting image data within the first image data extraction region to obtain the image data corresponding to the first editing object, and extracting image data within the second image data extraction region to obtain the image data corresponding to the second editing object.

In some embodiments, the image editing method further includes:
smoothing an edge of the first editing object in the first original layer and/or an edge of the second editing object in the second original layer based on a preset smoothing algorithm.

In some embodiments, the generating, based on the first editing layer and the second editing layer, a target image includes:
setting a transparency of an edge region of the first editing layer and an edge region of the second editing layer to a preset transparency, wherein the edge region is a region other than a region corresponding to an editing object in an editing layer; and
overlaying the first editing layer and the second editing layer on the original image to generate the target image.

In some embodiments, the overlaying the first editing layer and the second editing layer on the original image to generate the target image includes:
determining whether a region corresponding to the editing object of the first editing layer overlaps a region corresponding to the editing object of the second editing layer; and
in response to the region corresponding to the editing object of the first editing layer not overlapping the region corresponding to the editing object of the second editing layer, overlaying the first editing layer and the second editing layer on the original image in any order to generate the target image.

In some embodiments, if the region corresponding to the editing object of the first editing layer overlaps the region corresponding to the editing object of the second editing layer, obtaining a depth of the first editing object and a depth of the second editing object; and
overlaying the first editing layer and the second editing layer on the original image in a depth descending order to generate the target image.

In some embodiments, before the setting a transparency of an edge region of the first editing layer and an edge region of the second editing layer to a preset transparency, the image editing method further includes:
determining whether the first editing layer and the second editing layer include a shrank region, wherein the shrank region is a region that changes from the region corresponding to the editing object to the edge region after editing; and
in response to the first editing layer and the second editing layer comprising the shrank region, performing edge transitional filling on the shrank region, and setting the shrank region to the region corresponding to the editing object.

In a second aspect, an embodiment of the application provides an image editing apparatus including an obtaining unit, a generation unit, an editing unit and a processing unit.

The obtaining unit is configured to obtain an original image, wherein the original image includes a first editing object and a second editing object, and the first editing object and the second editing object are located in different image regions of the original image;

The generation unit is configured to render the first editing object and the second editing object to different layers, respectively, to generate a first original layer corresponding to the first editing object and a second original layer corresponding to the second editing object;

The editing unit is configured to render an editing result of the first editing object under a first editing operation based on the first original layer to generate a first editing layer corresponding to the first editing object, in response to the first editing operation for the first editing object, and render an editing result of the second editing object under a second editing operation based on the second original layer to generate a second editing layer corresponding to the second editing object in response to the second editing operation for the second editing object; and

The processing unit is configured to generate, based on the first editing layer and the second editing layer, a target image as an editing result of the original image.

In a third aspect, an embodiment of the application provides an electronic device, including a memory and a processor, wherein the memory is configured to store a computer program; and the processor is configured to, when invoking the computer program, causes the electronic device to implement the image editing method described in the first aspect or any one of the embodiments of the first aspect.

In a fourth aspect, an embodiment of the application provides a computer-readable storage medium storing a computer program, wherein the computer-readable storage medium, when executed by a computing device, causes the computing device to implement the image editing method described in the first aspect or any one of the embodiments of the first aspect.

In a fifth aspect, an embodiment of the application provides a computer program product, wherein the computer program product, when executing on a computer, causes the computer to implement the image editing method described in the first aspect or any one of the embodiments of the first aspect.

The image editing method provided in the embodiments of the present application includes: firstly obtaining an original image including a first editing object and a second editing object; then, rendering the first editing object and the second editing object to different layers, respectively, to generate a first original layer and a second original layer; subsequently, in response to a first editing operation for the first editing object, rendering an editing result of the first editing object under the first editing operation based on the first original layer to generate a first editing layer corresponding to the first editing object, and in response to a second editing operation for the second editing object, rendering an editing result of the second editing object under the second editing operation based on the second original layer to generate a second editing layer corresponding to the second editing object; and finally, generating, based on the first editing layer and the second editing layer, a target image as an editing result of the original image. Since the first original layer and the second original layer in the embodiments of the present application, and the first editing operation is performed on the first original layer while the second editing operation is performed on the second original layer, when the first editing object or the second editing object in the image is re-edited, only the first original layer or the second original layer needs to be re-edited and rendered without requiring re-rendering on all the editing objects in the original image. Therefore, the embodiments of the present application can solve the problem of enormous performance overhead when re-editing an object in an image during multi-object editing.

### BRIEF DESCRIPTION OF THE DRAWINGS

The accompanying drawings, which are incorporated in and constitute a part of this description, illustrate the embodiments of the present application and together with the description, serve to explain the principles of the present application.

To describe the technical solutions in the embodiments of the present application or in the prior art more clearly, the accompanying drawings required in the description of the embodiments or the prior art will be described briefly below. Apparently, other accompanying drawings can also be derived from these drawings by those ordinarily skilled in the art without creative efforts.

FIG. 1 is a first flowchart of an image editing method provided in an embodiment of the present application;

FIG. 2 is a first scene interface diagram of an image editing method provided in an embodiment of the present application;

FIG. 3 is a second scene interface diagram of an image editing method provided in an embodiment of the present application;

FIG. 4 is a schematic diagram of an editing layer in an image editing method provided in an embodiment of the present application;

FIG. 5 is a second flowchart of an image editing method provided in an embodiment of the present application;

FIG. 6 is a first schematic diagram of an editing object provided in an embodiment of the present application;

FIG. 7 is a second schematic diagram of an editing object provided in an embodiment of the present application;

FIG. 8. is a schematic diagram of a shrank region provided in an embodiment of the present application;

FIG. 9 is a schematic diagram of an edge region provided in an embodiment of the present application;

FIG. 10 is a schematic diagram of an image editing apparatus provided in an embodiment of the present application; and

FIG. 11 is a schematic diagram of a hardware structure of an electronic device provided in an embodiment of the present application.

### DETAILED DESCRIPTION

To provide a clearer understanding of the objective, features, and advantages of the present application, the solutions in the present application will be further described below. It needs to noted that the embodiments of the present application and the features in the embodiments can be combined with one another without conflict.

Many specific details are described in the following descriptions to help fully understand the present application. However, the present application may also be implemented in other manners different from those described herein. Apparently, the embodiments in this description are merely some rather than all of the embodiments of the present application.

In the embodiments of the present application, the word such as “exemplary” or “for example” means “serving as an example, instance or illustration”. Any embodiment or design solution described herein as “exemplary” or “for example” in the embodiments of the present application should not be construed as being more preferred or advantageous over other embodiments or design solutions. Exactly, the words such as “exemplary” or “for example” are intended to present related concepts specifically. Moreover, in the descriptions of the embodiments of the present application, unless otherwise specified, “a plurality of” means two or more.

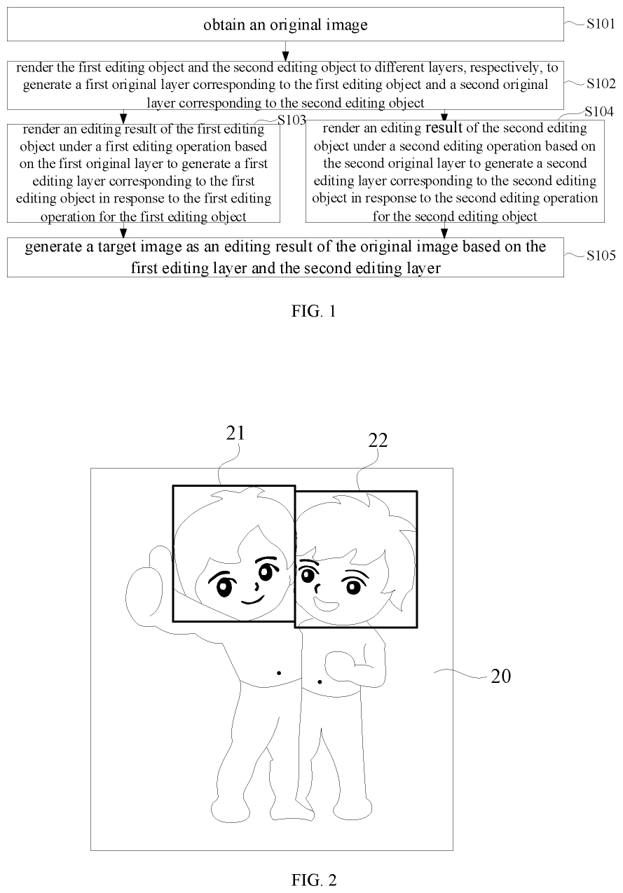

An embodiment of the present application provides an image editing method. With reference to FIG. 1, the image editing method includes the following steps.

S101, an original image is obtained.

The original image includes a first editing object and a second editing object, where the first editing object and the second editing object are located in different image regions of the original image.

It needs to be noted that the editing object (the first editing object and the second editing object) in the embodiment of the present application may be any element in the original image. For example, the editing object may be a human face, a tree, a lawn, sky, etc., which will not be limited in the embodiment of the present application.

The editing object in the embodiment of the present application may be automatically obtained by an image recognition algorithm. Exemplarily, with reference to FIG. 2, a first human face 21 and a second human face 22 in the original image 20 may be automatically recognized based on a human face recognition algorithm, and the recognized first human face 21 and second human face 22 are determined as the editing objects.

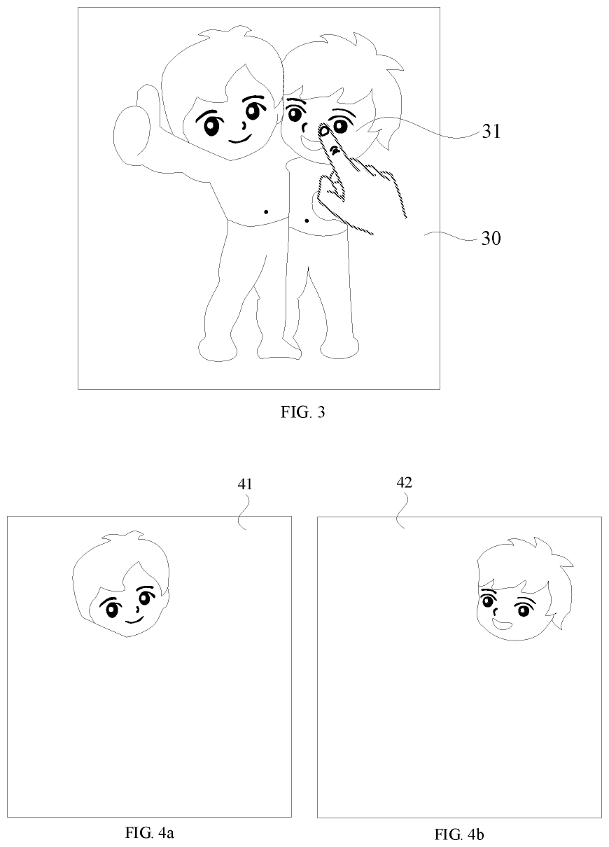

The editing object in the embodiment of the present application may also be selected by a user according to an editing requirement. Exemplarily, with reference to FIG. 3, when the original image 30 is displayed and a selection operation or an editing operation for a human face 31 to be edited is received from a user, the human face 31 to be edited is determined as the editing object in response to the selection operation or the editing operation of the user.

S102, the first editing object and the second editing object are rendered to different layers, respectively, to generate a first original layer corresponding to the first editing object and a second original layer corresponding to the second editing object.

In some embodiments, sizes and shapes of the first original layer and the second original layer may be the same as a size and a shape of the original image.

Exemplarily, with reference to FIG. 4, as shown by the editing objects in the example corresponding to FIG. 2, an original layer corresponding to the first human face 21 may be an original layer 41 shown in FIG. 4 (a), and an original layer corresponding to the second human face 22 may be an original layer 42 shown in FIG. 4 (b).

S103, an editing result of the first editing object under a first editing operation is rendered based on the first original layer to generate a first editing layer corresponding to the first editing object in response to the first editing operation for the first editing object.

S104, an editing result of the second editing object under a second editing operation is rendered based on the second original layer to generate a second editing layer corresponding to the second editing object in response to the second editing operation for the second editing object.

It needs to be noted that the embodiments of the present application are not limited to the above order of preforming steps S103 and S104. Step S103 may be performed first and then step S104 may performed; or, step S104 is performed first and then step S103 is performed; or, steps S103 and S104 are performed synchronously.

Further, each of the first editing operation and the second editing operation may be input by the user or determined automatically based on a beauty algorithm, a special effect addition algorithm, etc.

In some implementations, the first original layer and the second original layer may be displayed on the original image in an overlapping manner. When the user edits a certain original layer, the original layer is brought to front. Thus, the user, when editing a plurality of editing objects, will not perceive the existence of the original layers corresponding to the editing objects. In this way, the editing experience of the user can be improved.

S105, a target image is determined as an editing result of the original image based on the first editing layer and the second editing layer.

The image editing method provided in the embodiment of the present application includes: firstly obtaining an original image including a first editing object and a second editing object; then, rendering the first editing object and the second editing object to different layers, respectively, to generate a first original layer and a second original layer; subsequently, rendering an editing result of the first editing object under a first editing operation based on the first original layer to generate a first editing layer corresponding to the first editing object in response to the first editing operation for the first editing object,, and rendering an editing result of the second editing object under a second editing operation based on the second original layer to generate a second editing layer corresponding to the second editing object in response to the second editing operation for the second editing object; and finally, generating, based on the first editing layer and the second editing layer, a target image as an editing result of the original image. Since the first original layer and the second original layer in the embodiments of the present application, and the first editing operation is performed on the first original layer while the second editing operation is performed on the second original layer, when the first editing object or the second editing object in the image is re-edited, only the first original layer or the second original layer needs to be re-edited and rendered without requiring re-rendering on all the editing objects in the original image. Therefore, the embodiments of the present application can solve the problem of enormous performance overhead when re-editing an object in an image during multi-object editing.

It needs to be noted that the foregoing embodiment is described by taking for example editing two editing objects (the first editing object and the second editing object) in the original image, the embodiments of the present application are not limited to editing only two editing objects in the original image. On the basis of the foregoing embodiment, the image editing method provided in the embodiments of the present application is also capable of editing other number of editing objects in the original image. When editing other number of editing objects in the original image, operations performed on the editing objects are similar to the operations performed on the first editing object and the second editing object in the foregoing embodiment, which will not be described here redundantly.

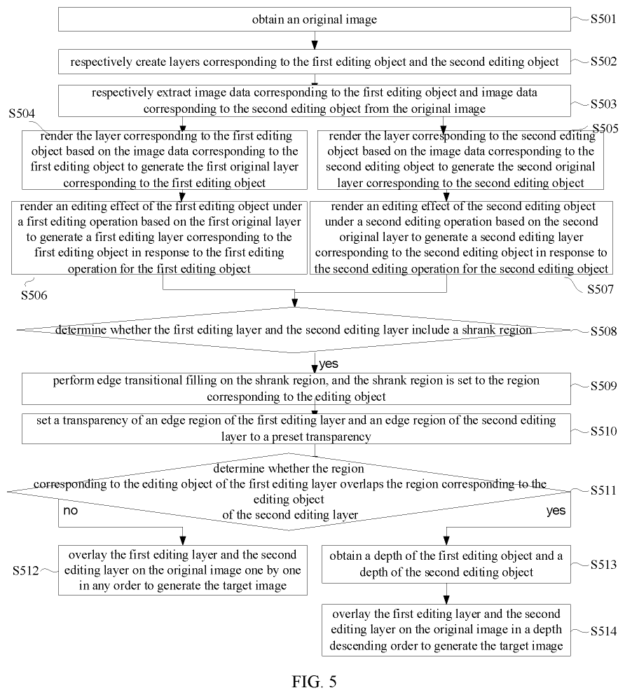

As extension and detailing of the foregoing embodiment, an embodiment of the present application provides another image editing method. With reference to FIG. 5, the image editing method includes the following steps.

S501, an original image is obtained.

The original image includes a first editing object and a second editing object, where the first editing object and the second editing object are located in different image regions of the original image.

S502, layers corresponding to the first editing object and the second editing object, respectively, are created.

That is, a corresponding blank layer is created for each of the first editing object and the second editing object.

In some embodiments, an implementation of step S502 may be as follows: when editing starts, a selection input for the first editing object and the second editing object in the original image is received from a user, and corresponding layers are created for the first editing object and the second editing object in response to the selection input of the user.

In some embodiments, an implementation of step S502 may be as follows: when an editing operation for the first editing object and the second editing object in the original image is received from the user, corresponding layers are created for the first editing object and the second editing object in response to the editing operation of the user.

S503, image data corresponding to the first editing object and image data corresponding to the second editing object are extracted separately from the original image.

In some implementations, an implementation of step S503 may include the following step a to step c.

Step a, an outline of the first editing object and an outline of the second editing object are determined from the original image.

Specifically, the outline of each editing object in the original image may be determined based on an image segmentation algorithm such as a histogram thresholding method, a region growing method, a random field modeling method, a relaxation labeling region segmentation method, a local image function method, and an image filtering method.

Step b, image data within the outline of the first editing object is extracted to obtain the image data corresponding to the first editing object.

Step c, image data within the outline of the second editing object is extracted to obtain the image data corresponding to the second editing object.

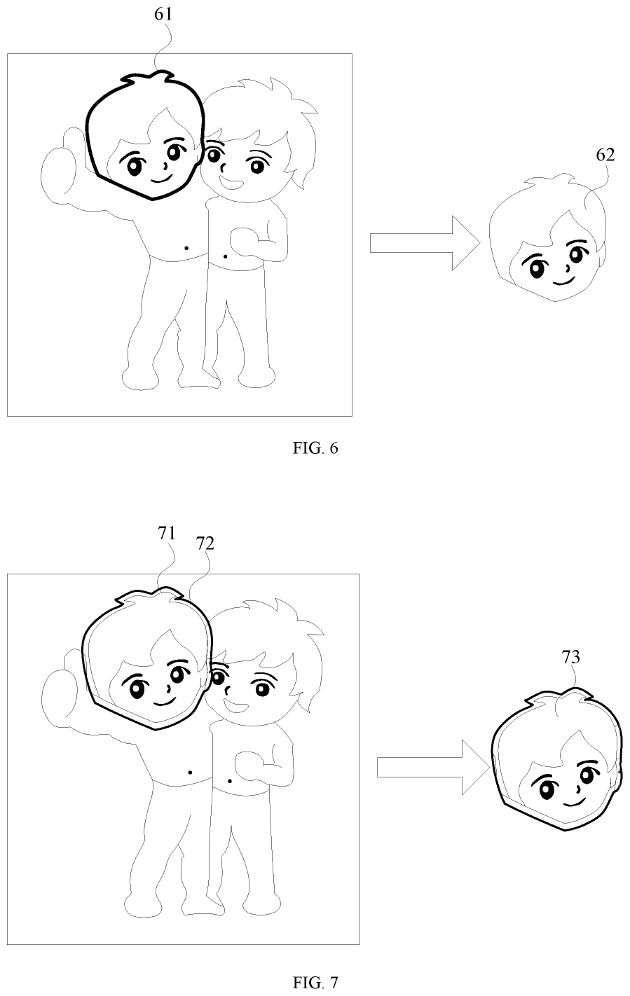

Exemplarily, with reference to FIG. 6, the outline of an editing object is as shown at 61 in FIG. 6 (in bold in FIG. 6), and therefore, the image data within the outline 61 is extracted as the image data corresponding to the editing object. Image rendering is performed based on the image data corresponding to the editing object to obtain an image, as shown at 62 in FIG. 6.

In some implementations, an implementation of step S503 may include the following steps I to step V.

Step I, an outline of the first editing object and an outline of the second editing object are determined from the original image.

Likewise, the outline of the first editing object and the outline of the second editing object may be determined based on the image segmentation algorithm such as the histogram thresholding method, the region growing method, the random field modeling method, the relaxation labeling region segmentation method, the local image function method, and the image filtering method.

Step II, a first image data extraction region corresponding to the first editing object is determined based on the outline of the first editing object.

The outline of the first editing object is located in the first image data extraction region.

Step III, a second image data extraction region corresponding to the second editing object is determined based on the outline of the second editing object.

The outline of the first editing object is located in the first image data extraction region.

In some embodiments, a minimum distance of each point in the edge of the image data extraction region corresponding to any editing object from the outline of the editing object is a preset distance.

Exemplarily, the preset distance may be a distance of N pixels, N being an integer.

Exemplarily, with reference to FIG. 7, the outline of the editing object is as shown at 71 in FIG. 7, and the image data extraction region corresponding to the editing object determined in the original image based on the outline 71 of the editing object is as shown at 72 in FIG. 7. Since the outline 71 of the editing object is located in the image data extraction region 72 corresponding to the editing object, an image obtained by rendering based on the extracted image data corresponding to the editing object is as shown at 73 in FIG. 7, which is slightly larger than the actual editing object.

Step IV, image data within the first image data extraction region is extracted to obtain the image data corresponding to the first editing object.

Step V, image data within the second image data extraction region is extracted to obtain the image data corresponding to the second editing object.

The editing object extracted in the foregoing embodiment is slightly larger than the actual editing object domain. Therefore, after editing each editing object, the edge of the editing object may be smoothed based on a smoothing algorithm such as feather without affecting the actual editing object. Thus, when a final effect picture is synthesized, the fusion effect of the boundary region is enhanced and the image processing effect is improved.

S504, the layer corresponding to the first editing object is rendered based on the image data corresponding to the first editing object to generate the first original layer corresponding to the first editing object.

S505, the layer corresponding to the second editing object is rendered based on the image data corresponding to the second editing object to generate the second original layer corresponding to the second editing object.

S506, an editing result of the first editing object under a first editing operation is rendered based on the first original layer to generate a first editing layer corresponding to the first editing object in response to the first editing operation for the first editing object.

S507, an editing result of the second editing object under a second editing operation is rendered based on the second original layer to generate a second editing layer corresponding to the second editing object in response to the second editing operation for the second editing object.

S508, whether the first editing layer and the second editing layer include a shrank region is determined.

The shrank region is a region that changes from the region corresponding to the editing object to the edge region after editing according to the editing operation corresponding to the editing object.

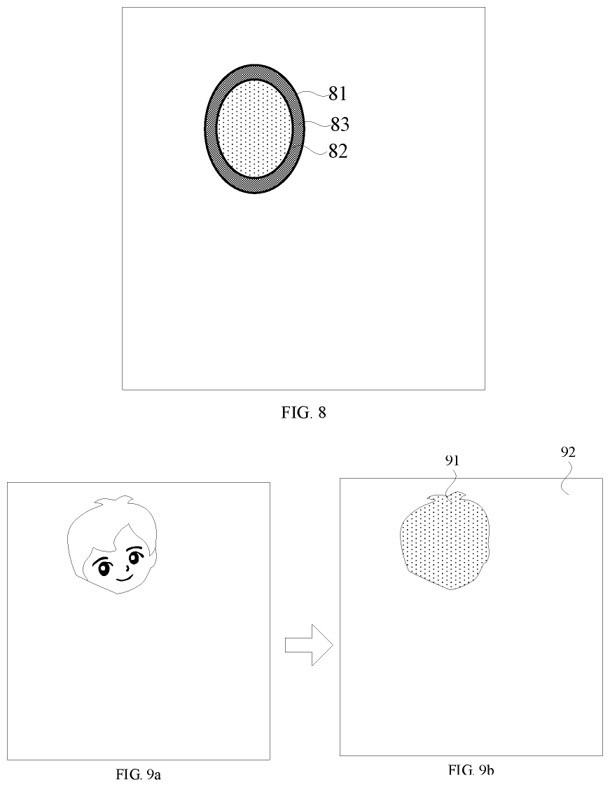

Exemplarily, with reference to FIG. 8, before editing according to the editing operation corresponding to the editing object, the outline of the editing object A is as shown at 81 in FIG. 8, and the region corresponding to the editing object A is the entire region within the outline 81 of the editing object A. After editing according to the editing operation corresponding to the editing object, the outline of the editing object A is as shown at 82 in FIG. 8, and the edge region includes the entire region outside the outline 82 of the editing object A after editing. After editing according to the editing operation corresponding to the editing object, an annular region 83 changes from the region corresponding to the editing object to the edge region. Therefore, the annular region 83 is the shrank region in the editing layer.

In the above step S508, if the first editing layer and/or the second editing layer include(s) the shrank region, the following step S509 is performed on the shrank region.

S509, edge transitional filling is performed on the shrank region, and the shrank region is set to the region corresponding to the editing object.

In the present embodiment, edge transitional filling is performed on the shrank region, and the shrank region is set to the region corresponding to the editing object. Therefore, it can be avoided that the editing object after editing cannot completely cover the original editing object in the original image, thus avoiding an image editing anomaly.

S510, a transparency of an edge region of the first editing layer and an edge region of the second editing layer is set to a preset transparency.

The edge region of the editing layer is a region other than the region corresponding to the editing object in the editing object.

In some embodiments, the preset transparency may be 100%.

Since the shrank region is set to the region corresponding to the editing object in the above step S510, the transparency of the shrank region may not be set to the preset transparency.

Exemplarily, with reference to FIG. 9, the editing layer obtained by editing the original layer corresponding to the editing object B according to the editing operation corresponding to the editing object B is as shown in FIG. 9 (a), and the region corresponding to the editing object in the editing layer is region 91 shown in FIG. 9 (b) and the edge region is region 92 shown in FIG. 9 (b). Therefore, the transparency of the region 92 is set to the preset transparency.

S511, whether the region corresponding to the editing object of the first editing layer overlaps the region corresponding to the editing object of the second editing layer is determined.

Whether the regions corresponding to the editing objects overlap after editing the editing objects is determined.

In the above step S511, if the region corresponding to the editing object of the first editing layer does not overlap the region corresponding to the editing object of the second editing layer, the following step S512 is performed.

S512, the first editing layer and the second editing layer are overlaid on the original image one by one in any order to generate the target image.

Exemplarily, the editing layers may be overlaid on the original image in an editing order to generate the target image.

In the above step S511, if the region corresponding to the editing object of the first editing layer overlaps the region corresponding to the editing object of the second editing layer, the following steps S513 and S514 are performed.

S513, a depth of the first editing object and a depth of the second editing object are obtained.

Specifically, the depth of the editing object in the embodiment of the present application may refer to a scene depth value of the editing object. Since the scene depth value at each position of the editing object may be different, the scene depth values of all pixels corresponding to the editing object may be obtained, and an average value of the scene depth value of the pixels is obtained as the depth of the editing object.

S514, the first editing layer and the second editing layer are overlaid on the original image in a depth descending order to generate the target image.

That is, the editing layer corresponding to the editing object having a greater depth is overlaid and then the editing layer corresponding to the editing object having a smaller depth is overlaid until all editing layers are overlaid on the original image, and the resulting image is the edited target image of the original image.

In the foregoing embodiment, when the regions corresponding to the editing objects of the editing layers overlap, the depths of the editing objects in the original image may also be obtained and the editing layers are overlaid on the original image in the depth descending order to generate the target image. Therefore, the covering relationship between the editing objects in the target image may conform to the actual situation observed by human eyes in the foregoing embodiment, thereby avoiding a covering relationship anomaly between the editing objects in the edited target image.

Further, an implementation of the above step S503 (image data corresponding to the first editing object and image data corresponding to the second editing object are extracted separately from the original image) includes: determining an outline of the first editing object and an outline of the second editing object from the original image; determining a first image data extraction region corresponding to the first editing object and a second image data extraction region corresponding to the second editing object based on the outline of the first editing object and the outline of the second editing object, respectively, where the outline of the first editing object is located in the first image data extraction region, and the outline of the second editing object is located in the second image data extraction region; and extracting image data within the first image data extraction region to obtain the image data corresponding to the first editing object, and extracting image data within the second image data extraction region to obtain the image data corresponding to the second editing object. The image editing method provided in the foregoing embodiment further includes:
smoothing an edge of the first editing object in the first original layer and/or an edge of the second editing object in the second original layer based on a preset smoothing algorithm.

Based on the same concept, as an implementation of the image editing method, an embodiment of the present application further provides an image editing apparatus. The apparatus embodiments correspond to the foregoing method embodiments. For ease of reading, the apparatus embodiments do not present the details in the foregoing method embodiments. However, it will be clear that the image editing apparatus in the present embodiment can correspond to all the contents in the foregoing method embodiments.

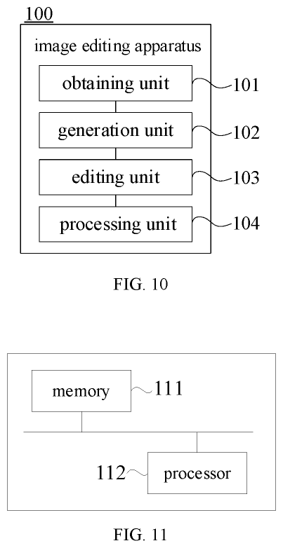

An embodiment of the present application provides an image editing apparatus. FIG. 10 is a structural schematic diagram of the image editing apparatus. As shown in FIG. 10, the image editing apparatus 100 includes:
an obtaining unit 101 configured to obtain an original image, where the original image includes a first editing object and a second editing object, and the first editing object and the second editing object are located in different image regions of the original image;
a generation unit 102 configured to render the first editing object and the second editing object to different layers, respectively, to generate a first original layer corresponding to the first editing object and a second original layer corresponding to the second editing object;
an editing unit 103 configured to, render an editing result of the first editing object under a first editing operation based on the first original layer to generate a first editing layer corresponding to the first editing object in response to the first editing operation for the first editing object, and render an editing result of the second editing object under a second editing operation based on the second original layer to generate a second editing layer corresponding to the second editing object in response to the second editing operation for the second editing object; and
a processing unit 104 configured to generate, based on the first editing layer and the second editing layer, a target image as an editing result of the original image.

In some implementations, the generation unit 102 is specifically configured to: create layers corresponding to the first editing object and the second editing object, respectively, separately extracting image data corresponding to the first editing object and image data corresponding to the second editing object from the original image; and rendering the layer corresponding to the first editing object based on the image data corresponding to the first editing object to generate the first original layer corresponding to the first editing object, and rendering the layer corresponding to the second editing object based on the image data corresponding to the second editing object to generate the second original layer corresponding to the second editing object.

In some implementations, the generation unit 102 is specifically configured to: determine an outline of the first editing object and an outline of the second editing object from the original image; and extract image data within the outline of the first editing object to obtain the image data corresponding to the first editing object, and extract image data within the outline of the second editing object to obtain the image data corresponding to the second editing object.

In some implementations, the generation unit 102 is specifically configured to: determine an outline of the first editing object and an outline of the second editing object from the original image; determine a first image data extraction region corresponding to the first editing object and a second image data extraction region corresponding to the second editing object based on the outline of the first editing object and the outline of the second editing object, respectively, where the outline of the first editing object is located in the first image data extraction region, and the outline of the second editing object is located in the second image data extraction region; and extract image data within the first image data extraction region to obtain the image data corresponding to the first editing object, and extract image data within the second image data extraction region to obtain the image data corresponding to the second editing object.

In some implementations, the processing unit 104 is further configured to: smooth an edge of the first editing object in the first original layer and/or an edge of the second editing object in the second original layer based on a preset smoothing algorithm.

In some implementations, the processing unit 104 is specifically configured to: set a transparency of an edge region of the first editing layer and an edge region of the second editing layer to a preset transparency, where the edge region is a region other than a region corresponding to an editing object in an editing layer; and overlay the first editing layer and the second editing layer on the original image to generate the target image.

The edge region is a region other than a region corresponding to an editing object in an editing layer.

In some implementations, the processing unit 104 is specifically configured to: determine whether the region corresponding to the editing object of the first editing layer overlaps the region corresponding to the editing object of the second editing layer; and if the region corresponding to the editing object of the first editing layer does not overlap the region corresponding to the editing object of the second editing layer, overlay the first editing layer and the second editing layer on the original image in any order to generate the target image.

In some implementations, the processing unit 104 is specifically configured to: obtain a depth of the first editing object and a depth of the second editing object; and overlay the first editing layer and the second editing layer on the original image in a depth descending order to generate the target image.

In some implementations, the processing unit 104 is specifically configured to: before setting the transparency of the edge region of the first editing layer and the edge region of the second editing layer to the preset transparency, determine whether the first editing layer and the second editing layer include a shrank region, where the shrank region is a region that changes from the region corresponding to the editing object to the edge region after editing; and if yes, perform edge transitional filling on the shrank region, and set the shrank region to the region corresponding to the editing object.

The image editing apparatus provided in the present embodiment can perform the image editing method provided in the foregoing method embodiments, and the implementation principles and technical effects are similar, which will not be described herein.

Based on the same concept, an embodiment of the present application further provides an electronic device. FIG. 11 is a structural schematic diagram of an electronic device provided in an embodiment of the present application. As shown in FIG. 11, the electronic device provided in the present embodiment includes a memory 111 and a processor 112, where the memory 111 is configured to store a computer program; and the processor 112 is configured to perform the image editing method provided in the foregoing embodiments when invoking the computer program.

Based on the same concept, an embodiment of the present application further provides a computer-readable storage medium. A computer program is stored on the computer-readable storage medium, and when executed by a processor, causes a computing device to implement the image editing method provided in the foregoing embodiments.

Based on the same concept, an embodiment of the present application further provides a computer program product which, when running on a computer, causes the computer to implement the image editing method provided in the foregoing embodiments.

Those skilled in the art should understand that the embodiments of the present application may be provided as a method, a system, or a computer program product. Therefore, the present application may use a form of hardware only embodiments, software only embodiments, or embodiments with a combination of software and hardware. Moreover, the present application may take the form of a computer program product that is implemented on one or more computer-usable storage media that include computer-usable program code.

The processor may be a central processing unit (CPU), and may also be other general-purpose processor, a digital signal processor (DSP), an application specific integrated circuit (ASIC), a field-programmable gate array (FPGA) or other programmable logic device, a discrete gate, a transistor logic device, a discrete hardware component, etc. The general-purpose processor may be a microprocessor, or the processor may be any conventional processor, etc.

The memory may include a non-permanent memory in a computer-readable medium and may take the form of a random access memory (RAM) and/or a non-volatile memory, such as a read only memory (ROM) or a flash RAM. The memory is an example of the computer-readable medium.

The computer-readable medium includes permanent and non-permanent, removable and non-removable storage mediums. The storage medium may realize information storage by any method or technique. The information may be computer-readable instructions, data structures, program modules, or other data. Examples of the storage medium of the computer include but are not limited to a phase-change RAM (PRAM), a static random access memory (SRAM), a dynamic random access memory (DRAM), other types of RAMs and ROMs, an electrically erasable programmable read-only memory (EEPROM), a flash memory or other memory techniques, a compact disk read-only memory (CD-ROM), a digital versatile disc (DVD), or other optical storage, a cassette type magnetic tape, disk storage, or other magnetic storage device, or nay other non-transmission medium, that can be used to store information accessible by computing devices. According to the definitions herein, the computer-readable medium does not include transitory computer-readable media, such as modulated data signals and carriers.

Finally, it should be noted that the above embodiments are merely used to explain the technical solutions of the present application, but are not intended to limit the present application. Although the present application is described in detail with reference to the foregoing embodiments, those of ordinary skill in the art should understand that they can still modify the technical solutions described in the foregoing embodiments, or make equivalent substitutions on some or all technical features therein. These modifications or substitutions do not make the essence of the corresponding technical solutions deviate from the spirit and scope of the technical solutions of the embodiments of the present application.

1. An image editing method, comprising:
obtaining an original image, wherein the original image comprises a first editing object and a second editing object, and the first editing object and the second editing object are in different image regions of the original image;
rendering the first editing object and the second editing object to different layers respectively, to generate a first original layer corresponding to the first editing object and a second original layer corresponding to the second editing object;
rendering an editing result of the first editing object under a first editing operation based on the first original layer to generate a first editing layer corresponding to the first editing object in response to the first editing operation for the first editing object, and rendering an editing result of the second editing object under a second editing operation based on the second original layer to generate a second editing layer corresponding to the second editing object in response to the second editing operation for the second editing object; and
generating, based on the first editing layer and the second editing layer, a target image as an editing result of the original image.

2. The image editing method according to claim 1, wherein the rendering the first editing object and the second editing object to different layers respectively, to generate a first original layer corresponding to the first editing object and a second original layer corresponding to the second editing object comprises:
creating layers corresponding to the first editing object and the second editing object, respectively;
extracting separately image data corresponding to the first editing object and image data corresponding to the second editing object from the original image; and
rendering the layer corresponding to the first editing object based on the image data corresponding to the first editing object to generate the first original layer corresponding to the first editing object, and rendering the layer corresponding to the second editing object based on the image data corresponding to the second editing object to generate the second original layer corresponding to the second editing object.

3. The image editing method according to claim 2, wherein the extracting separately image data corresponding to the first editing object and image data corresponding to the second editing object from the original image comprises:
determining an outline of the first editing object and an outline of the second editing object from the original image; and
extracting image data within the outline of the first editing object to obtain the image data corresponding to the first editing object, and extracting image data within the outline of the second editing object to obtain the image data corresponding to the second editing object.

4. The image editing method according to claim 2, wherein the extracting separately image data corresponding to the first editing object and image data corresponding to the second editing object from the original image comprises:
determining an outline of the first editing object and an outline of the second editing object from the original image;
determining a first image data extraction region corresponding to the first editing object and a second image data extraction region corresponding to the second editing object based on the outline of the first editing object and the outline of the second editing object, respectively, wherein the outline of the first editing object is in the first image data extraction region, and the outline of the second editing object is in the second image data extraction region; and
extracting image data within the first image data extraction region to obtain the image data corresponding to the first editing object, and extracting image data within the second image data extraction region to obtain the image data corresponding to the second editing object.

5. The image editing method according to claim 4, further comprising:
smoothing an edge of the first editing object in the first original layer and/or an edge of the second editing object in the second original layer based on a preset smoothing algorithm.

6. The image editing method according to claim 2, wherein the generating, based on the first editing layer and the second editing layer, a target image comprises:
setting a transparency of an edge region of the first editing layer and an edge region of the second editing layer to a preset transparency, wherein the edge region is a region in an editing layer except for a region corresponding to an editing object; and
overlaying the first editing layer and the second editing layer on the original image, respectively, to generate the target image.

7. The image editing method according to claim 6, wherein the overlaying the first editing layer and the second editing layer respectively on the original image to generate the target image comprises:
determining whether a region corresponding to the first editing object of the first editing layer overlaps a region corresponding to the second editing object of the second editing layer; and
in response to the region corresponding to the first editing object of the first editing layer not overlapping the region corresponding to the second editing object of the second editing layer, overlaying the first editing layer and the second editing layer on the original image in any order to generate the target image.

8. The image editing method according to claim 7, wherein
in response to the region corresponding to the first editing object of the first editing layer overlapping the region corresponding to the second editing object of the second editing layer, obtaining a depth of the first editing object and a depth of the second editing object; and
overlaying the first editing layer and the second editing layer on the original image in a depth descending order to generate the target image.

9. The image editing method according to claim 6, before the setting a transparency of an edge region of the first editing layer and an edge region of the second editing layer to a preset transparency, further comprising:
determining whether the first editing layer and the second editing layer comprise a shrank region, wherein the shrank region is a region that changes from the region corresponding to the editing object to the edge region after editing; and
in response to the first editing layer and the second editing layer comprising the shrank region, performing edge transitional filling on the shrank region, and setting the shrank region to the region corresponding to the editing object.

10. An image editing apparatus, comprising:
an obtaining unit, configured to obtain an original image, wherein the original image comprises a first editing object and a second editing object, and the first editing object and the second editing object are in different image regions of the original image;
a generation unit, configured to render the first editing object and the second editing object to different layers, respectively, to generate a first original layer corresponding to the first editing object and a second original layer corresponding to the second editing object;
an editing unit, configured to render an editing result of the first editing object under a first editing operation based on the first original layer to generate a first editing layer corresponding to the first editing object, in response to the first editing operation for the first editing object, and render an editing result of the second editing object under a second editing operation based on the second original layer to generate a second editing layer corresponding to the second editing object in response to the second editing operation for the second editing object; and
a processing unit, configured to generate, based on the first editing layer and the second editing layer, a target image as an editing result of the original image.

11. An electronic device, comprising a memory and a processor, wherein the memory is configured to store a computer program; and the processor is configured to, when invoking the computer program, cause the electronic device to implement an image editing method, and the image editing method comprises:
obtaining an original image, wherein the original image comprises a first editing object and a second editing object, and the first editing object and the second editing object are in different image regions of the original image;
rendering the first editing object and the second editing object to different layers respectively, to generate a first original layer corresponding to the first editing object and a second original layer corresponding to the second editing object;
rendering an editing result of the first editing object under a first editing operation based on the first original layer to generate a first editing layer corresponding to the first editing object in response to the first editing operation for the first editing object, and rendering an editing result of the second editing object under a second editing operation based on the second original layer to generate a second editing layer corresponding to the second editing object in response to the second editing operation for the second editing object; and
generating, based on the first editing layer and the second editing layer, a target image as an editing result of the original image.

12. A computer-readable storage medium storing a computer program, wherein the computer program, when executed by a computing device, causes the computing device to implement the image editing method according to claim 1.

13. (canceled)
